(19) United States
(12) Patent Application Publication
(10) Pub. No.: US 2009/0212926 A1
(43) Pub. Date: Aug. 27, 2009

(54) Baby Monitor

(76) Inventors: Ruoping Du, Guangzhou (CN); Qiwei Xiao, Antioch, CA (US)

Correspondence Address: QIWEI XIAO, 3333 Bowers Ave Suite 130, Santa Clara, CA, 95054, US

(21) Appl. No.: 12/036,239

(22) Filed: Feb. 23, 2008

(51) Int. Cl. G05B 11/01

(52) U.S. Cl. 340/310.11

(57) ABSTRACT

A baby monitor which eliminates potential harmful microwave effect of wireless signal generated by current wireless baby monitors. The baby monitor has a nursery unit, a parent unit, and optionally a gateway. The nursery unit consists of video or audio acquisition, amplifier, microcontroller, microcontroller-controlled band-pass filter, microcontroller-controlled carrier generator and modulator, power line coupling circuitry. It transmits signal to the parent unit or the gateway through power line. Parent unit includes power line coupling circuit, micro-controller, microcontroller-controlled band pass filter, super-heterodyne amplifier, video/audio modulator and video/audio player. Alternatively, the power coupling circuit, microcontroller, microcontroller-controlled band-pass filter and super-heterodyne amplifier in the parent unit can be separated and form a gateway device which then communicates with the parent unit wirelessly.

### FIELD OF THE INVENTION

The invention relates to baby monitors.

### BACKGROUND INFORMATION

Baby monitors that allow remote monitoring of a baby are well-known. The device typically includes a nursery unit which is placed in a room with a baby or infant who is either playing or sleeping, and a parent unit which is located in another part of the house or building where the parent or guardian is. The two are connected wirelessly. The nursery unit detects sounds made by the baby or the video of the baby, and wirelessly transmits the sound or video to the parent unit where it is output via a speaker or video display.

Safety can be a problem with known baby monitors. The radio frequency of existing baby monitor in the market is all above 1 Ghz. Such high frequency may generate microwave radiation.

Under normal circumstances so as to listen or observe better the parents usually place the nursery unit very close to the baby. However, because the body and nerve system of babies are still in early development state, their cells are very sensitive and their body are especially susceptible to radiation. The purpose of baby monitor is for their safety. However, the radiation may put them in harm's way. Related reports can be found by the newspaper Independence on May 20, 2007, and the following two links:
http://www.safewireless.org/SWIGlobalNews/GeneralEMR/tabid/189/ctl/Article View/mid/466/articleId/373/Radiation-from-baby-monitors-poses-rist.aspx and http://www.safekids.co.uk/AreDigitalBabyMonitorsSafe.html

### SUMMARY OF THE INVENTION

The purpose of this invention is to overcome the shortcomings of existing baby monitors whose radio frequency radiation may potentially affect the health of babies.

The invention uses a safer means to transfer signal between the nursery unit and the parent unit.

It is an object of the present invention to provide a baby monitor which overcomes or ameliorates the above mentioned problems.

According to a first aspect of the invention there is provided a baby monitor including: a nursery unit, power line and a parent unit where the signal output terminal of the nursery unit is plugged directly into the power outlet socket; the signal input and output terminals of the parent unit are plugged directly into the power outlet socket; said nursery unit is connected to said parent unit by power line. The audio or video signal captured by the nursery unit modulates a carrier signal which is then sent to the power line. The parent unit receives the modulated carrier, demodulates and replays the audio or video signal.

In the nursery unit, the signal is transmitted at low frequency (below 200 KHz) alone power line instead of using high radio frequency. Therefore, it eliminates potential harmful effect to the baby.

Preferably, the nursery unit includes: power line coupling circuit, used to couple the carrier signal in power line to parent unit; at least one band-pass filer used to select and amplify signal from power line; microcontroller used to control the center frequency of said band-pass filter and determine the frequency of carrier signal; at least one demodulator, used to demodulate the audio or video signal from the carrier; audio amplifier or video processing circuitry, used to process and replay the voice or video signal demodulated from the carrier.

Preferably, the parent unit includes: power line coupling circuitry used to couple the carrier signal of the nursery unit from and to the power line; band-pass filter to select and amplify the signal from power line so as to measure the signal-to-noise ratio at each frequencies; microcontroller to control the center frequency of said band-pass filter, measure the signal-to-noise ratio at each frequencies, determines and controls the frequency of the carrier signal generated by the carrier generator; audio or video capture circuit consisting of microphone or video camera to acquire audio or video of the baby; at least one carrier generator to generate at least one carrier signal for transmitting the acquired audio and video signal to power line; at least one modulator to modulate the audio and video signal to the carrier.

Preferably, the power line coupling circuit consists of a high frequency transformer and a capacitor in tandem. The capacitor is used to cut off 50 Hz or 60 Hz low frequency signal and allow high frequency carrier signal to pass. The high-frequency transformer is used to allow the pass of high frequency signal and cut off 50 HZ or 60 HZ power frequency, and isolate the unit from power line.

According to a second aspect of the invention there is provided another baby monitor including a nursery unit, power line, gateway and a parent unit where the input and output terminals of the nursery unit are plugged directly into power line socket; one signal input terminal of said gateway is plugged directly into the power outlet socket and is connected to the nursery unit by the power line, it also contains another signal output terminal for wireless transmitter used to connect to the parent unit; One of the signal input terminal of said parent unit is a wireless receiver device. It connects to the gateway wirelessly and receives the high frequency carrier signal from the gateway.

Preferably, the nursery unit includes: power line coupling circuitry used to couple the carrier signal from/to the power line; band-pass filter to select and amplify the signal from power line so as to measure the signal-to-noise ratio at each frequencies; microcontroller to control the center frequency of said band-pass filter, measure the signal-to-noise ratio at each frequencies, determine and control the frequency of carrier signal generated by the carrier generator; audio or video capture circuitry consisting of microphone or video camera to acquire audio or video of the baby; at least one carrier generator to generate at least one carrier signal for transmitting the acquired audio and video signal to power line; at least one modulator to modulate the audio and video signal to the carrier.

Preferably, the gateway contains power line coupling circuit used to couple the carrier signal in power line to gateway; at least one band-pass filer used to select and amplify signal from power line; microcontroller, used to control the central frequency of the band-pass filter and determine the frequency point of carrier signal; at least one demodulator, used to demodulate the audio or video signal from the carrier; at least one wireless modulator used to modulate the audio or video signal to radio frequency carrier which is then amplified and transmitted to space to be received by the parent unit.

Preferably, the parent unit has at least one wireless receiving amplifier used to amplify radio frequency carrier received from the antenna; at least one demodulator used to demodulate audio or video signal from the high frequency carrier; audio amplifier or video process circuit, used to process and play back the demodulated audio or video signal.

Preferably, the power line coupling circuit consists of a high frequency transformer and a capacitor in tandem, the capacitor is used to cut off 50 HZ or 60 HZ low frequency signal and allow high frequency signal to pass. The high-frequency transformer is used to allow the pass of high frequency signal and cut off 50 HZ or 60 HZ power frequency, and isolate the unit from power line. The frequency of the carrier signal transmitted through power line is between 60 KHz to 200 KHz.

The benefit of this invention is that the signal between nursery unit and parent unit is transmitted through power line instead of by radio frequency wireless through space. Moreover, the carrier frequency of the transmission is very low: below 200 KHz. Therefore, there is no radiation at nursery unit. This eliminates potential harmful effect to the babies.

### BRIEF DESCRIPTION OF THE DRAWINGS

An embodiment of the invention will now be described by way of example only and with reference to the accompanying drawing, in which:

FIG. 1 is a schematic diagram of a first nursery unit for a baby monitor,

FIG. 2 is a schematic of a first parent unit for a baby monitor according to the invention,

FIG. 3 is a schematic of a gateway unit for a baby monitor,

FIG. 4 is a schematic of a second parent unit for a baby monitor with gateway,

FIG. 5 illustrates a system of band pass filter with tunable center frequency,

FIG. 6 is a schematic of a power coupling circuit,

FIG. 7 illustrates a carrier generator and modulator.

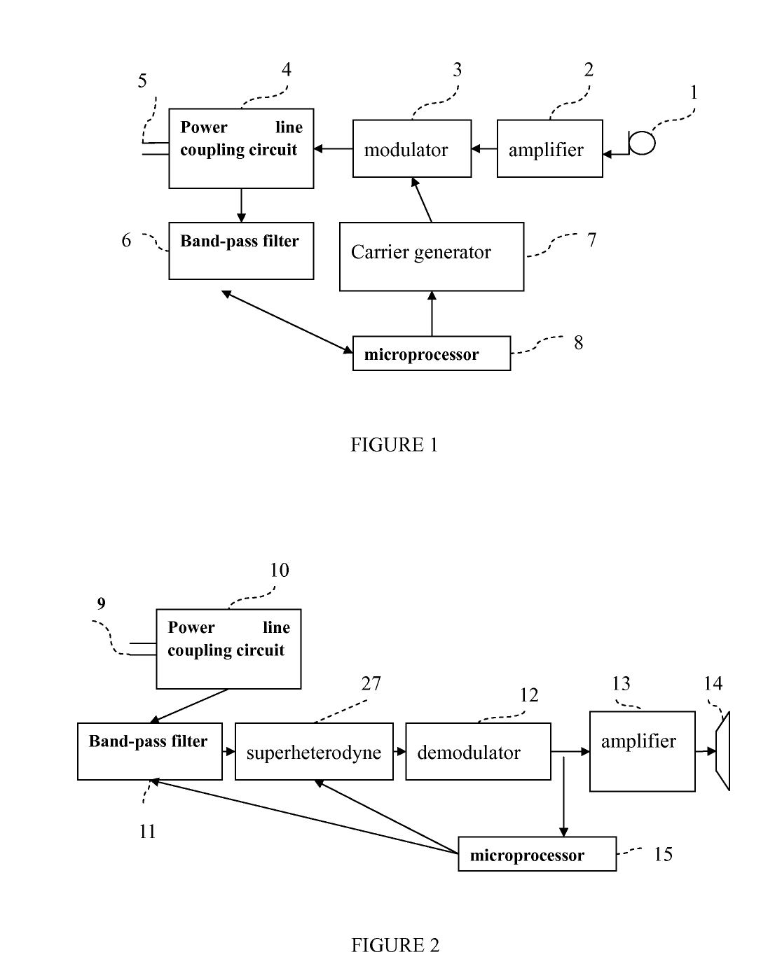

Referring to FIGS. 1 and 2, a baby monitor includes a nursery unit and one or more parent units. In FIG. 1, the nursery unit includes microphone 1, amplifier 2, modulator 3, power line coupling circuit 4, power line socket 5, variable center frequency band-pass filter 6, carrier generator 7 and microprocessor 8.

In FIG. 1, the audio signal detected by microphone 1 is amplified and enters modulator 3 for modulation. Carrier signal is generated by carrier generator 7 which is controlled by microcontroller 8. Carrier signal is sent to the power line through coupling circuit. 5 is power line plug inserted into the power socket.

There are many appliances and electric devices connected to the power line, such as all kinds of motors, switching power supplies, SCR (Silicon Controller Rectifier) power controller, and so on. Long power lines are also susceptible to radio interferences. Therefore, there are noises with wide range of frequency in power line. Because the various devices connected to it, the equivalent impedance of power line is very low, in the range of 1 Ohm to 20 Ohms. So the condition of power line transmission is very harsh. For example, if we select an arbitrary frequency in range of 60 KHz to 200 KHz as described above for transmission, it is hard to guarantee the signal quality.

This invention utilizes a frequency with maximum signal to noise ratio for transmission. The frequency with maximum signal to noise ratio is determined by using the variable center frequency band pass filter, microcontroller and the following method.

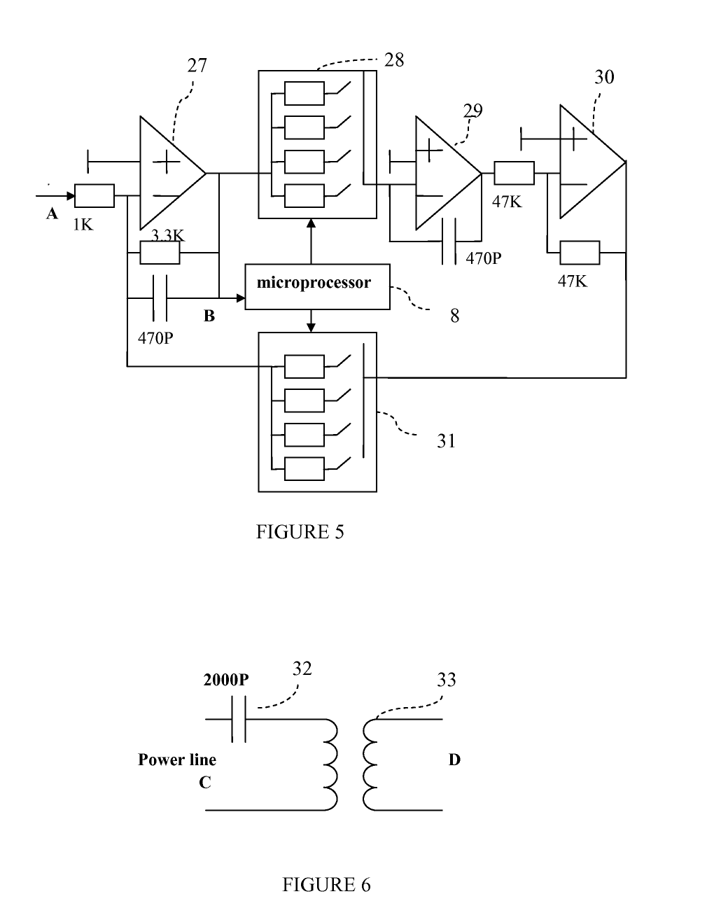

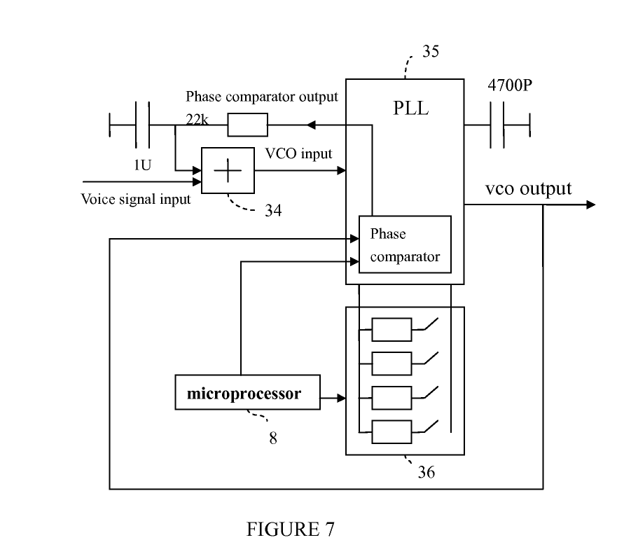

The detailed working principle of band-pass filter in FIG. 1 is shown in FIG. 5. Signal comes in from point A and goes out from point B. It passes the A/D converter in the microcontroller and enters the microcontroller. Three operational amplifiers 27, 29 and 30 form the band pass filter. According to related regulations, carrier frequency will be between 60 khz and 200 khz. Microcontroller controls switch 28 and 30, changes the resistor in the loop so as to change the center frequency of the band pass filter. Analog multiplexer can use 74 HC4052. On the power line, there is variety of noise with different frequency and magnitude which will adversely affect the quality of signal. Therefore, we must improve the signal to noise ratio so as to successfully transmit signal via power line. The method in this invention is to use a microcontroller to control an analog multiplexer in one of several positions (for example, 4 positions) to keep the center frequency of the band-pass filter between 60 khz to 200 khz as F1, F2, F3 and F4. Microcontroller reads the voltage N1, N2, N3 and N4 under each center frequency at point B. Those are the noise level in the power line at the frequency F1, F2, F3 and F4. Subsequently, in FIG. 7, microcontroller controls multiple switches 36 to change the resistor value so as to make the carrier frequency generated by the PLL 35 F1, F2, F3 and F4, respectively. According to FIG. 1, carrier signal goes into the power line through coupling circuit.

At the same time, in FIG. 5, the center frequency of band-pass filter controlled by the microcontroller 8 is F1, F2, F3 and F4, respectively. Moreover, the microcontroller reads the voltage S1, S2, S3 and S4 at point B under each frequency. Obviously, those voltages are proportional to the signal magnitude. The microcontroller compute the Si/Ni value (i=1, 2, 3, 4) under each frequency. Whichever channel with the highest Si/Ni value is the channel having the best signal to noise ratio. This is the channel the nursery unit chooses to transmit signal to guarantee best results. This optimal frequency can reduce the adverse effect of noise and low impedance in power line at maximum extent and guarantee the best receiving results.

This optimal transmission frequency can be static or dynamic. Static means that during the last use, once the nursery unit determined the optimal frequency, it keeps on using the same frequency for all subsequent transmissions. Dynamic means even it determines the optimal frequency, it still searches for a new one every so often using the procedure described above. Once it finds one, it will use the new optimal frequency for transmission.

The audio signal acquired at the nursery unit is modulated using Frequency Modulation (FM) onto the carrier in the optimal frequency. This is achieved by the well-known Phase Lock Loop (PLL) Frequency Modulation. One example of PLL IC is 74 HC4046. The microcontroller outputs carrier directly which enters the phase comparator input. The center frequency of PLL equals the carrier frequency.

FIG. 7 is the carrier generator and audio FM modulator, mainly consists of microcontroller 8, Phase Lock Loop (PLL) 34, adder 34, multiple-path switch 36. The microcontroller determines the carrier frequency according to the procedure described above and selects one path of the multiple-path switch. The resistor in this path and the 4700 pf capacitor together determine the center frequency of the PLL. This is also the carrier frequency. The carrier frequency signal from the microcontroller and the Voltage Controlled Oscillator (VCO) enters the phase comparator in the PLL. Its output is filtered by a low-pass filter and is added with amplified audio signal acquired by the microphone. The combined signal is then frequency modulated onto the optimal channel selected.

During the modulation of audio signal, at a fixed interval such as 60 seconds, the transmission of audio signal is temporarily suspended. Instead, a series of synchronization code is transmitted. For example, the code can be 256 pulses of 101010. The width of the pulses is 1 ms so the total length of pulses is 256 ms. Since the synchronization code only takes 256 ms out of 60 seconds, it almost has no effect to the audio signal transmission. After transmitting synchronized code, the audio signal transmission is resumed immediately. Synchronization code is used for the parent unit to identify the optimal frequency being used.

The modulated signal is power amplified and enters the D terminal of the coupling circuit in FIG. 6.

The generation and amplification of carrier are all considered low power electronics. Eventually they need to be connected to power line which is considered high power electronics. Therefore, there must be circuit connecting low power circuitry and high power circuitry. This is coupling circuit. It needs to greatly reduce or even eliminate the interference of high power line to the low power circuit. At the same time, it needs to send the low power carrier signal to high power line without too much reduction. A capacitor with appropriate value can serve this purpose. It exhibits high impedance to 50 or 60 Hz power line signal frequency while exhibits low impedance to 60-200 KHz carrier frequency. To further enhance its effect and isolate high power circuit from low power circuit, a high-frequency transformer can be used.

As shown in FIG. 6, coupling circuit consists of high frequency transformer 33 and capacitor. The capacitor is used to cut off 50 HZ or 60 HZ power line signal and other low frequency noise, and allow high frequency signal to pass. High frequency transformer is used to allow high frequency carrier signal to pass and cut off 50 Hz or 60 hz power line signal. As a result, carrier signal is coupled to the power line C terminal and power line voltage is isolated. Here the value of the capacitor is 0.047 uf. The transformer has a 1 cm magnetic toroidal core with primary winding and secondary winding all 20 turns.

Therefore, in the process of transmitting audio modulated carrier signal, no wireless radio frequency is used. This completely eliminates the potential health effect of radio frequency to the babies.

Same as nursery unit, the parent unit also need to have coupling circuit to connect to power line so as to eliminate its interference and allow the carrier signal to pass. The schematic and parameters of coupling circuit are the same as those in the nursery unit. After the carrier signal enters the parent unit through power line, how does the parent unit receive the signal? How does the parent unit know what frequency the nursery unit transmits on? As an example, we assume that the nursery unit and the parent unit decide that they will use one of F1, F2, F3 or F4 as carrier frequency. After the parent unit is powered up, its microcontroller adjusts the band pass filter so the center frequency is one of F1, F2, F3 or F4. It receives carrier signal at each frequency and demodulates the carrier signal. The receiver uses the well-known super-heterodyne scheme.

The microcontroller directly outputs local oscillator frequency based on the current carrier frequency to the super-heterodyne amplifier. Suppose local oscillator frequency is FL, carrier frequency is F and intermediate frequency is FI then the three satisfy the following relationship: F+FL=FI. Intermediate frequency is selected as a fixed number, for example, 455 KHz. When the center frequency of the band pass filter controlled by the micro-controller is F1, F2, F4 or F4, the local oscillator frequency should be 455−F1, 455−F2, 455−F3 and 455−F4, respectively. The transmission frequency is determined by both the center frequency of the band pass filter controlled by the micro-controller and local oscillator frequency. In other words, the center frequency of the band pass filter is the carrier frequency. The local oscillator frequency is the difference between 455 Khz and carrier frequency.

The micro-controller searches whether there are 256 pulse sequences with width 1 ms in the demodulated audio signal. When it detects such synchronization code, it decides that this is the frequency the nursery unit is used to for transmission. After detecting the synchronization code, every 60 seconds, the micro-controller is going to suspend the audio signal for 250 ms, and search the synchronization code again during that period. Because the audio signal is suspended, the synchronization is not heard by users. If it can't detect any synchronization code in the frequency currently used, the micro-controller will change the center frequency of the band pass filter and the local oscillator to search the synchronization code in the next possible carrier frequency. As such, no matter the nursery unit uses static or dynamic optimal frequency the parent unit can capture it and uses that frequency to receive signal.

The parent unit in FIG. 2 contains power plug 9, coupling circuit 10, variable center frequency band-pass filter 11, super-heterodyne amplifier 27, demodulator 12, audio amplifier 13 and speaker 14.

There is an IC which integrates super-heterodyne amplifier 27 and demodulator 12. It is suitable to use here. The model is MC3361. 9 is power plug inserted into power socket. The carrier signal on the power line passes through plug 9 and enters coupling circuit 10. Similarly, in the coupling circuit as shown in FIG. 6, signal enters through point C, is coupled to point D and then enter band-pass filter. As shown in FIG. 5, the center frequency is controlled by microcontroller 15. It changes the center frequency of the band-pass filter as F1, F2, F3 and F4. The local oscillator frequency output directly is 455−F1, 455−F2, 455−F3 and 455−F4 is sent to super-heterodyne 27 until it detects the audio signal at the output of the FM demodulator. At that time it can then determines the carrier frequency of the nursery unit. The center frequency of the band-pass filter controlled by the microcontroller will then stay at this value. It will continue receive audio signal from the nursery unit. The audio signal is amplified by audio amplifier 13 and played back by speaker 14.

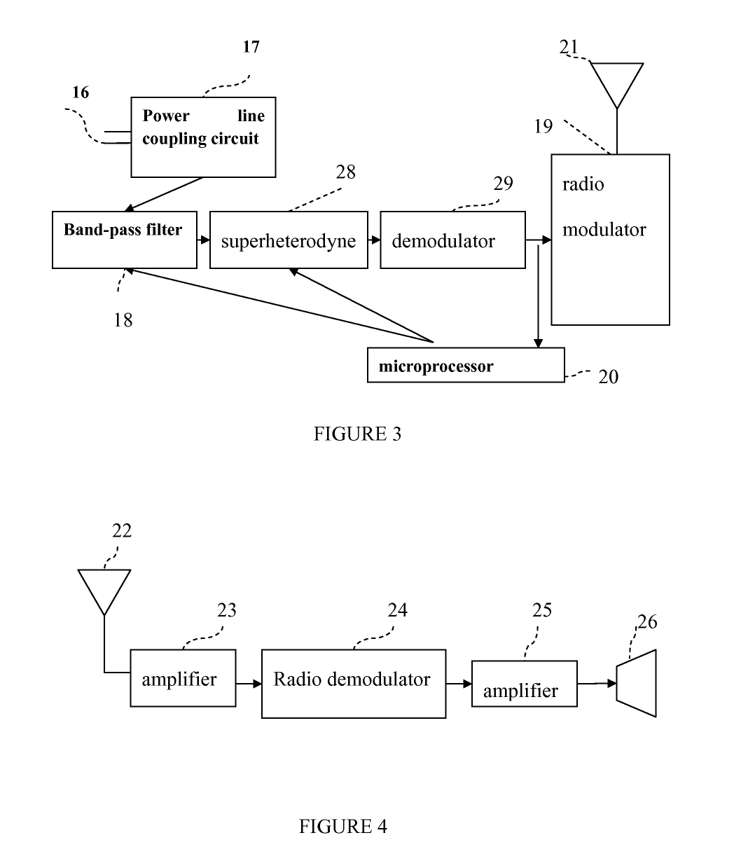

The parent unit described above is appropriate for a majority of applications. However, there are exceptions such as in a situation where there is no power outlet to plug in the parent unit. In those situations people can use the wireless gateway shown in FIG. 3 and the parent unit shown in FIG. 4. The nursery unit will remain the same. The wireless gateway in FIG. 3 consists of power line coupling circuit, microcontroller, band-pass filter and frequency-modulation (FM) demodulator. It works the same way as the parent unit in FIG. 2 before the output of audio signal.

The purpose of using wireless gateway is that we can move the parent unit freely because of the convenience brought by wireless. The location of the nursery unit can remain fixed to avoid the potential harmful effect of wireless radio signal to the babies.

The wireless gateway in FIG. 3 contains power plug 16, power line coupling circuit 17, microcontroller 20, variable center frequency band pass filter 18, super-heterodyne amplifier 28, demodulator 29, wireless modulator 19 and antenna 20.

The structure of wireless gateway in FIG. 3 is almost the same as the parent unit in FIG. 2. Comparing FIG. 3 and FIG. 2, in FIG. 3 before wireless modulator 19 and in FIG. 2 before audio amplifier 13, the wireless gateway and the parent unit work the same way. Software is also the same. The difference between wireless gateway and parent unit is that the demodulated audio signal is no longer sent to the speaker. Instead the signal is sent to wireless modulator 19 for modulating a fixed radio frequency carrier and transmitted to space.

In this invention, the parent unit that uses wireless gateway is the same as that without using the wireless gateway. The parent unit using wireless gateway in FIG. 4 is completely identical to the common radio receiver. It includes antenna 22, amplifier 23 and demodulator 24. It demodulates the audio signal which then drives speaker 26 to play back the audio. Although the gateway uses radio frequency to send signal, it is located far from the baby room. For example, it can be located in a different room, or even on a different floor. Its radio frequency radiation is greatly reduced by the building. Even if parents may place the nursery unit close to the baby, the radiation source is the gateway which is far from the baby, this will not affect the health of the baby.

If we would like to send video signal using the baby monitor, the configuration and working principle are largely the same. The only difference is that in the nursery unit we need to have not only a microphone but also a video capture device and digitizer. In the parent unit the demodulated digital video signal needs to be converted to analog signal and played back on a small LCD or CRT display.

Another difference is that the data rate of video signal is much larger than that of audio signal. To meet the data rate requirement, we can divide the whole available frequency band into more frequency points under the condition that there is enough guard band. In the procedure of determining optimal frequency, we order the frequencies by the value of signal to noise ratio, and use multiple frequencies for transmission. For example, if there are 8 transmission frequencies. We select 3 frequencies with the best signal to noise ratio for transmission. Microcontroller will divide the data into 3 parts and transmit the data in 3 frequencies. As a result, the data rate is 3 times of that using one frequency. In the parent unit, there need to be 3 variable center frequency band pass filters, 3 super-heterodyne amplifiers. Same as the procedure described above using one single optimal frequency, the microcontroller searches for the synchronization code, determines 3 optimal frequencies and receives signal at those frequencies simultaneously. It then constructs the video signal back to its original based on the way the nursery unit divided the signal. The video signal is then replayed on display.

Embodiments of the invention having been described, however it is understood that variations, improvements or modifications can take place without departure from the spirit of the invention or scope of the appended claims.

What is claimed is:

1. A baby monitor including: a nursery unit, power line and a parent unit wherein
A. The signal output terminal of said nursery unit is plugged directly into the power outlet socket;
B. The signal input and output terminals of said parent unit are plugged directly into the power outlet socket;
C. Said nursery unit is connected to said parent unit by power line, The audio or video signal captured by said nursery unit modulates a carrier signal which is then sent to the power line, Said parent unit receives the modulated carrier, demodulates and replays the audio or video signal.

2. The baby monitor of claim 1 wherein said parent unit includes:
Power line coupling circuitry used to couple the carrier signal of the nursery unit to the power line and the signal in power line to the nursery unit;
Band-pass filter to select and amplify the signal from power line so as to measure the signal-to-noise ratio at each frequencies;
Microcontroller to control the center frequency of said band-pass filter, measure the signal-to-noise ratio at each frequencies, determines and controls the frequency of the carrier signal generated by the carrier generator;
Audio or video capture circuit consisting of microphone or video camera to acquire audio or video of the baby;
At least one carrier generator to generate at least one carrier signal for transmitting the acquired audio and video signal to power line;
At least one modulator to modulate the audio and video signal to the carrier.

3. The baby monitor of claim 1 wherein said nursery unit includes:
Power line coupling circuit, used to couple the carrier signal in power line to parent unit;
At least one band-pass filer used to select and amplify signal from power line;
Microcontroller, used to control the center frequency of said band-pass filter and determine the frequency of carrier signal;
At least one demodulator, used to demodulate the audio or video signal from the carrier;
Audio amplifier or video processing circuitry, used to process and replay the voice or video signal demodulated from the carrier.

4. The baby monitor of claim 2 or 3 wherein said power line coupling circuitry consists of a high frequency transformer and a capacitor in tandem. The capacitor is used to cut off 50 HZ or 60 HZ low frequency signal and allow high frequency carrier signal to pass, the high-frequency transformer is used to allow the pass of high frequency signal and cut off 50 HZ or 60 HZ power frequency, and isolate the unit from power line.

5. A baby monitor including a nursery unit, power line, gateway and a parent unit wherein
A. The input and output terminals of said nursery unit are plugged directly into power line socket;
B. One signal input terminal of said gateway is plugged directly into the power outlet socket and is connected to the nursery unit by the power line, it also contains another signal output terminal for wireless transmitter used to connect to said parent unit;
C. One of the signal input terminal of said parent unit is a wireless receiver device, it connects to said gateway wirelessly and receives the high frequency carrier signal from the gateway.

6. The baby monitor of claim 5 wherein said nursery unit includes:
Power line coupling circuitry used to couple the carrier signal of the nursery unit to the power line and the signal in power line to the nursery unit;
Band-pass filter to select and amplify the signal from power line so as to measure the signal-to-noise ratio at each frequencies;
Microcontroller to control the center frequency of said band-pass filter, measure the signal-to-noise ratio at each frequencies, determine and control the frequency of carrier signal generated by the carrier generator;
Audio or video capture circuitry consisting of microphone or video camera to acquire audio or video of the baby;
At least one carrier generator to generate at least one carrier signal for transmitting the acquired audio and video signal to power line;
At least one modulator to modulate the audio and video signal to the carrier.

7. The baby monitor of claim 5 wherein said gateway contains power line coupling circuit used to couple the carrier signal in power line to gateway;
At least one band-pass filer used to select and amplify signal from power line;
Microcontroller, used to control the central frequency of the band-pass filter and determine the frequency point of carrier signal;
At least one demodulator, used to demodulate the audio or video signal from the carrier;
At least one wireless modulator used to modulate the audio or video signal to radio frequency carrier which is then amplified and transmitted to space to be received by the parent unit.

8. The baby monitor of claim 5 wherein said parent unit has at least one wireless receiving amplifier used to amplify radio frequency carrier received from the antenna;
At least one demodulator used to demodulate audio or video signal from the high frequency carrier;
Audio amplifier or video process circuit, used to process and play back the demodulated audio or video signal.

9. The baby monitor of claim 6 or 7 wherein said power line coupling circuitry consists of a high frequency transformer and a capacitor in tandem, the capacitor is used to cut off 50 HZ or 60 HZ low frequency signal and allow high frequency signal to pass, the high-frequency transformer is used to allow the pass of high frequency signal and cut off 50 HZ or 60 HZ power frequency, and isolate the unit from power line.
